(19) United States
(12) Patent Application Publication
(10) Pub. No.: US 2018/0012306 A1
(43) Pub. Date: Jan. 11, 2018

(54) SYSTEM AND METHOD FOR DETERMINING TRANSACTION LOCATIONS BASED ON GEOCODED INFORMATION

(71) Applicant: Capital One Financial Corporation, McLean, VA (US)

(72) Inventor: Richard S. JUST, Ravendale, CA (US)

(21) Appl. No.: 15/711,066

(22) Filed: Sep. 21, 2017

Related U.S. Application Data
(63) Continuation of application No. 14/211,165, filed on Mar. 14, 2014.
(60) Provisional application No. 61/791,092, filed on Mar. 15, 2013.

(51) Int. Cl. G06Q 40/00

(52) U.S. Cl. CPC G06Q 40/12

(57) ABSTRACT

Systems and methods for determining a transaction location based on transaction history data include storing, in a database, transaction history data related to a plurality of account holders, storing, in a database, location data for a plurality of locations, wherein each of the plurality of locations is associated with a respective merchant store location, receiving, via a network, transaction data associated with one of the plurality of account holders' recent transaction, obtaining, using a processor, the location data for a plurality of locations, retrieving, using a processor, transaction history data associated with the account holder from a transaction history data store associated with a financial institution, creating transactions clusters based on the transaction history data, analyzing a location associated with each of the transaction clusters and the location data, and determining a predicted transaction location based on the analysis of the one or more transaction clusters and the location data.

### CROSS-REFERENCE TO RELATED APPLICATIONS

This application claims priority to U.S. Provisional Patent Application No. 61/791,092, filed on Mar. 15, 2013, the entire contents of which is incorporated herein by reference.

### FIELD OF THE DISCLOSURE

The present disclosure relates to systems and methods for determining transaction locations based on geocoded information.

### BACKGROUND OF THE DISCLOSURE

Currently, transaction data received from a Point of Sale (PoS) terminal at a merchant may include geographic information (e.g., “geocoded information”). The geocoded information may include a city, state, or zip code, but often may not include a street address, latitude, or longitude. In situations where a merchant has multiple locations in a single city or zip code, this presents a problem for the recipient in determining at which specific location the transaction was conducted.

These and other drawbacks exist.

### SUMMARY OF THE DISCLOSURE

According to example embodiments, a system for determining a transaction location based on transaction history data includes a first database that stores transaction history data related to a plurality of account holders, a second database that stores location data for a plurality of locations, wherein each of the plurality of locations is associated with a respective merchant store location, a receiver that receives, via a network, transaction data associated with one of the plurality of account holders' recent transaction, a location data processor that obtains the location data for a plurality of locations, a transaction history processor that retrieves transaction history data associated with the account holder from a transaction history data store associated with a financial institution, a location prediction processor that creates one or more transactions clusters based on the transaction history data, analyzes a location associated with each of the transaction clusters and the location data, and determines a predicted transaction location based on the analysis of the one or more transaction clusters and the location data. In such embodiments, the predicted transaction location is one of the plurality of locations associated with the respective merchant store locations.

Also, the receiver receives a merchant identifier associated with the transaction data, the transaction history processor retrieves transaction history data for a plurality of other account holders based on the merchant identifier, and the location prediction processor creates one or more transaction clusters for each of the plurality of other account holders based on the retrieved transaction history data, compares a location associated with each of the transaction clusters with the location data, and updates the predicted transaction location based the comparison between the one or more transaction clusters and the location data.

According to example embodiments, a method for determining a transaction location based on transaction history data includes storing, in a first database, transaction history data related to a plurality of account holders, storing, in a second database, location data for a plurality of locations, wherein each of the plurality of locations is associated with a respective merchant store location, receiving, via a network, transaction data associated with one of the plurality of account holders' recent transaction, obtaining, using a location data processor, the location data for a plurality of locations, retrieving, using a transaction history processor, transaction history data associated with the account holder from a transaction history data store associated with a financial institution, creating, using a location prediction processor, one or more transactions clusters based on the transaction history data, analyzing, using the location prediction processor, a location associated with each of the transaction clusters and the location data, and determining, using the location prediction processor, a predicted transaction location based on the analysis of the one or more transaction clusters and the location data. In such embodiments, the predicted transaction location is one of the plurality of locations associated with the respective merchant store locations.

The method also may include receiving a merchant identifier associated with the transaction data, retrieving, using the transaction history processor, transaction history data for a plurality of other account holders based on the merchant identifier, creating, using the location prediction processor, one or more transaction clusters for each of the plurality of other account holders based on the retrieved transaction history data, comparing, using the location prediction processor, a location associated with each of the transaction clusters with the location data, and updating, using the location prediction processor, the predicted transaction location based the comparison between the one or more transaction clusters and the location data.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 depicts a schematic diagram of a system for determining a transaction location based on geocoded information;

FIG. 2 depicts an example of a map overlaid with purchase clusters according to an example embodiment of the disclosure;

FIG. 3 an example of a map overlaid with purchase clusters according to an example embodiment of the disclosure;

FIG. 4 depicts an example of a map overlaid with purchase clusters according to an example embodiment of the disclosure;

FIG. 5 depicts a schematic diagram of a method for determining a transaction location based on geocoded information, according to an example embodiment of the disclosure;

FIG. 6 depicts an example point of sale system according to an example embodiment of the disclosure; and

FIG. 7 a schematic diagram of a system for determining a transaction location based on geocoded information.

### DETAILED DESCRIPTION OF THE EMBODIMENTS

The following description is intended to convey a thorough understanding of the embodiments described by providing a number of specific example embodiments and details involving systems and methods for determining a transaction location based on geocoded information. It should be appreciated, however, that the present disclosure is not limited to these specific embodiments and details, which are examples only. It is further understood that one possessing ordinary skill in the art, in light of known systems and methods, would appreciate the use of the invention for its intended purposes and benefits in any number of alternative embodiments, depending on specific design and other needs. A financial institution and system supporting a financial institution are used as examples for the disclosure. The disclosure is not intended to be limited to financial institutions only.

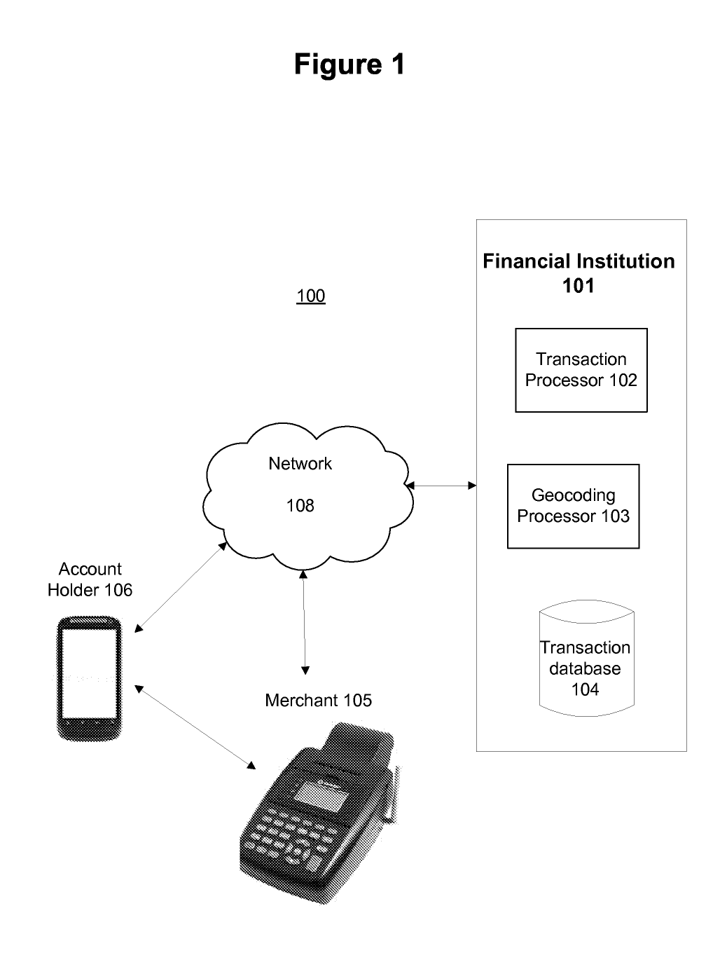

FIG. 1 depicts an example embodiment of a system for determining a transaction location based on geocoded information associated with an account holder's past transactions, according to various embodiments of the disclosure. The system may include various network-enabled computer systems, including, as depicted in FIG. 1 for example, a financial institution 101; a transaction processor 102, a geocoding processor 103, and transaction database 104, which may be included as separate processors or combined into device having a single processor or device having the multiple processors. It is also noted that the system 100 illustrates only a single instance of each component. It will be appreciated that multiple instances of these components may be used. Moreover, the system 100 may include other devices not depicted in FIG. 1.

In various embodiments, transaction processor 102, geocoding processor 103, and/or transaction database 104 may be separate from financial institution 101. Processor 102, geocoding processor 103, and/or transaction database 104 also may be integrated into merchant 105, or with one or more third-party systems. As referred to herein, a network-enabled computer system and/or device may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The network-enabled computer systems may execute one or more software applications to, for example, receive data as input from an entity accessing the network-enabled computer system, process received data, transmit data over a network, and receive data over a network. The one or more network-enabled computer systems may also include one or more software applications to determine one or more transaction locations based on geocoded information.

The components depicted in FIG. 1 may store information in various electronic storage media, such as, for example, transaction database 104. Electronic information, files, and documents may be stored in various ways, including, for example, a flat file, indexed file, hierarchical database, relational database, such as a product database created and maintained with software from, for example, Oracle® Corporation, Microsoft® Excel file, Microsoft® Access file, or any other storage mechanism.

The components depicted in FIG. 1 may be coupled via one or more networks, such as, for example, network 108. Network 108 may be one or more of a wireless network, a wired network or any combination of wireless network and wired network. For example, network 108 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11b, 802.15.1, 802.11n and 802.11g or any other wired or wireless network for transmitting and receiving a data signal.

In addition, network 108 may include, without limitation, telephone lines, fiber optics, IEEE Ethernet 902.3, a wide area network (“WAN”), a local area network (“LAN”), or a global network such as the Internet. Also network 108 may support an Internet network, a wireless communication network, a cellular network, or the like, or any combination thereof. Network 108 may further include one network, or any number of the example types of networks mentioned above, operating as a stand-alone network or in cooperation with each other. Network 108 may utilize one or more protocols of one or more network elements to which they are communicatively coupled. Network 108 may translate to or from other protocols to one or more protocols of network devices. Although network 108 is depicted as a single network, it should be appreciated that according to one or more embodiments, network 108 may comprise a plurality of interconnected networks, such as, for example, the Internet, a service provider's network, a cable television network, corporate networks, and home networks.

In various example embodiments, an account holder 106 may be any individual or entity that desires to conduct a financial transaction using one or more accounts held at one or more financial institutions. Also, account holder 106 may be a computer system associated with or operated by such an individual or entity. An account may include any place, location, object, entity, or other mechanism for holding money or performing transactions in any form, including, without limitation, electronic form. An account may be, for example, a credit card account, a prepaid card account, stored value card account, debit card account, check card account, payroll card account, gift card account, prepaid credit card account, charge card account, checking account, rewards account, line of credit account, credit account, mobile device account, an account or service that links to an underlying payment account already described, or mobile commerce account. A financial institution may be, for example, a bank, other type of financial institution, including a credit card provider, for example, or any other entity that offers accounts to customers. An account may or may not have an associated card, such as, for example, a credit card for a credit account or a debit card for a debit account. The account may enable payment using biometric authentication, or contactless based forms of authentication, such as QR codes or near-field communications. The account card may be associated or affiliated with one or more social networking sites, such as a co-branded credit card.

Merchant 105 may be a physical location having one or more point of sale (PoS) terminals where an account holder can swipe one or more cards to conduct a transaction. The PoS terminals may be equipped with card readers, as is well known in the art. The PoS terminals may be equipped with Near Field Communication (NFC) capabilities which can conduct a transaction with an NFC-equipped mobile device. The PoS terminals may be mobile devices. As used herein, the term mobile device may be, for example, a handheld PC, a phone, a smartphone, a PDA, a tablet computer, or other device. Exemplary NFC standards include ISO/IEC 18092:2004, which defines communication modes for Near Field Communication Interface and Protocol (NFCIP-1). For example, a mobile device or other PoS terminal may be configured using the Isis Mobile Wallet™ system, which is incorporated herein by reference. Other example NFC standards include those created by the NFC Forum.

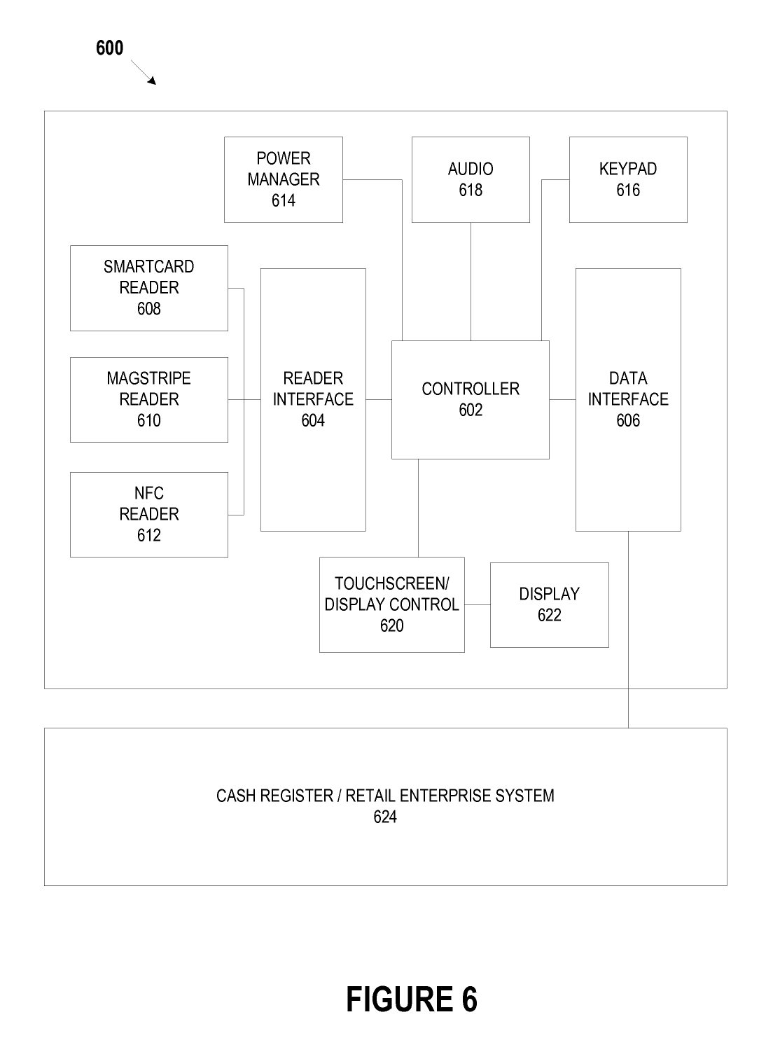

FIG. 6 depicts an example PoS device 600. PoS device 600 may provide the interface at what a customer or end user makes a payment to the merchant in exchange for goods or services. PoS device 600 may include and/or cooperate with weighing scales, scanners, electronic and manual cash registers, electronic funds transfer at point of sale (EFTPOS) terminals, touch screens and any other wide variety of hardware and software available for use with PoS device 600. PoS device 600 may be a retail point of sale system and may include a cash register and/or cash register-like computer components to enable purchase transactions. PoS device 600 also may be a hospitality point of sale system and include computerized systems incorporating registers, computers and peripheral equipment, usually on a computer network to be used in restaurant, hair salons, hotels or the like. PoS device 600 may be a wireless point of sale device similar to a PoS device described herein or, for example a tablet computer that is configured to operate as a PoS device, including for example, software to cause the tablet computer to execute point of sale functionality and a card reader such as for example the Capital One® SparkPay card reader, the Square® reader, Intuit's® GoPayment reader, or the like. PoS device 600 also may be a cloud-based point of sale system that can be deployed as software as a service, which can be accessed directly from the Internet using, for example, an Internet browser.

Referring to FIG. 6, an example PoS device 600 is shown. PoS device 600 may include a controller 602, a reader interface 604, a data interface 606, a smartcard reader 608, a magnetic stripe reader 610, a near-field communications (NFC) reader 612, a power manager 614, a keypad 616, an audio interface 618, a touchscreen/display controller 620, and a display 622. Also, PoS device 600 may be coupled with, integrated into or otherwise connected with a cash register/retail enterprise system 624.

In various embodiments, Controller 602 may be any controller or processor capable of controlling the operations of PoS device 600. For example, controller 602 may be a Intel® 2nd Generation Core™ i3 or i5 or Pentium™ G850 processor or the like. Controller 602 also may be a controller included in a personal computer, smartphone device, tablet PC or the like.

Reader interface 604 may provide an interface between the various reader devices associated with PoS device 600 and PoS device 600. For example, reader interface 604 may provide an interface between smartcard reader 608, magnetic stripe reader 610, NFC reader 612 and controller 602. In various embodiments, reader interface 604 may be a wired interface such as a USB, RS232 or RS485 interface and the like. Reader interface 604 also may be a wireless interface and implement technologies such as Bluetooth, the 802.11(x) wireless specifications and the like. Reader interface 604 may enable communication of information read by the various reader devices from the various reader devices to PoS device 600 to enable transactions. For example, reader interface 604 may enable communication of a credit or debit card number read by a reader device from that device to PoS device 600. In various embodiments, reader interface 604 may interface between PoS device 600 and other devices that do not necessarily “read” information but instead receive information from other devices.

Data interface 606 may allow PoS device 600 to pass communicate data throughout PoS device and with other devices including, for example, cash register/retail enterprise system 624. Data interface 606 may enable PoS device 600 to integrate with various customer resource management (CRM) and/or enterprise resource management (ERP) systems. Data interface 606 may include hardware, firmware and software that make aspects of data interface 606 a wired interface. Data interface 606 also may include hardware, firmware and software that make aspects of data interface 606 a wireless interface. In various embodiments, data interface 606 also enables communication between PoS device other devices.

Smartcard reader 608 may be any electronic data input device that reads data from a smart card. Smartcard reader 608 may be capable of supplying an integrated circuit on the smart card with electricity and communicating with the smart card via protocols, thereby enabling read and write functions. In various embodiments, smartcard reader 608 may enable reading from contact or contactless smart cards. Smartcard reader 608 also may communicate using standard protocols including ISO/IEC 7816, ISO/IEC 14443 and/or the like or proprietary protocols.

Magnetic stripe reader 610 may be any electronic data input device that reads data from a magnetic stripe on a credit or debit card, for example. In various embodiments, magnetic stripe reader 610 may include a magnetic reading head capable of reading information from a magnetic stripe. Magnetic stripe reader 610 may be capable of reading, for example, cardholder information from tracks 1, 2, and 3 on magnetic cards. In various embodiments, track 1 may be written on a card with code known as DEC SIXBIT plus odd parity and the information on track 1 may be contained in several formats (e.g., format A, which may be reserved for proprietary use of the card issuer; format B; format C-M which may be reserved for us by ANSI subcommittee X3B10; and format N-Z, which may be available for use by individual card issuers). In various embodiments, track 2 may be written with a 5-bit scheme (4 data bits plus 1 parity). Track 3 may be unused on the magnetic stripe. In various embodiments, track 3 transmission channels may be used for transmitting dynamic data packet information to further enable enhanced token-based payments and/or determining locations based on geocoded information, such as, for example, merchant information and/or additional location information.

NFC reader 612 may be any electronic data input device that reads data from a NFC device. In an example embodiment, NFC reader 612 may enable Industry Standard NFC Payment Transmission. For example, the NFC reader 612 may communicate with a NFC enabled device to enable two loop antennas to form an air-core transformer when placed near one another by using magnetic induction. NFC reader 612 may operate at 13.56 MHz or any other acceptable frequency. Also, NFC reader 612 may enable a passive communication mode, where an initiator device provides a carrier field, permitting answers by the target device via modulation of existing fields. Additionally, NFC reader 612 also may enable an active communication mode by allowing alternate field generation by the initiator and target devices.

In various embodiments, NFC reader 612 may deactivate an RF field while awaiting data. NFC reader 612 may receive communications containing Miller-type coding with varying modulations, including 100% modulation. NFC reader 612 also may receive communications containing Manchester coding with varying modulations, including a modulation ratio of approximately 10%, for example. Additionally, NFC reader 612 may be capable of receiving and transmitting data at the same time, as well as checking for potential collisions when the transmitted signal and received signal frequencies differ.

NFC reader 612 may be capable of utilizing standardized transmission protocols, for example but not by way of limitation, ISO/IEC 14443 A/B, ISO/IEC 18092, MiFare, FeliCa, tag/smartcard emulation, and the like. Also, NFC reader 612 may be able to utilize transmission protocols and methods that are developed in the future using other frequencies or modes of transmission. NFC reader 612 also may be backwards-compatible with existing payment techniques, such as, for example RFID. Also, NFC reader 612 may support transmission requirements to meet new and evolving payment standards including internet based transmission triggered by NFC. In various embodiments, NFC reader 612 may utilize MasterCard's® PayPass and/or Visa's® PayWave and/or American Express′® ExpressPay systems to enable transactions.

Although not shown and described, other input devices and/or readers, such as for example, barcode readers and the like are contemplated.

Power manager 614 may be any microcontroller or integrated circuit that governs power functions of PoS device 600. Power manager 614 may include, for example, firmware, software, memory, a CPU, a CPU, input/output functions, timers to measure intervals of time, as well as analog to digital converters to measure the voltages of the main battery or power source of PoS device 600. In various embodiments, Power manager 614 remain active even when PoS device 600 is completely shut down, unused, and/or powered by the backup battery. Power manager 614 may be responsible for coordinating many functions, including, for example, monitoring power connections and battery charges, charging batteries when necessary, controlling power to other integrated circuits within PoS device 600 and/or other peripherals and/or readers, shutting down unnecessary system components when they are left idle, controlling sleep and power functions (on and off), managing the interface for built-in keypad and trackpads, and/or regulating a real-time clock (RTC).

Keypad 616 may any input device that includes a set of buttons arranged, for example, in a block or pad and may bear digits, symbols and/or alphabetical letters. Keypad 616 may be a hardware-based or mechanical-type keypad and/or implemented in software and displayed on, for example, a screen or touch screen to form a keypad. Keypad 616 may receive input from a user that pushed or otherwise activates one or more buttons on keypad 616 to provide input.

Audio interface 618 may be any device capable of providing audio signals from PoS device 600. For example, audio interface may be a speaker or speakers that may produce audio signals. In various embodiments, audio interface 618 may be integrated within PoS device 600. Audio interface 618 also may include components that are external to PoS device 600.

Touchscreen/display control 620 may be any device or controller that contrals an electronic visual display. Touchscreen/display control 620 may allow a user to interact with PoS device 600 through simple or multi-touch gestures by touching a screen or display (e.g., display 622). Touchscreen/display control 620 may be configured to control any number of touchscreens, including, for example, resistive touchscreens, surface acoustic wave touchscreens, capacitive touchscreens, surface capacitance touchscreens, projected capacitance touchscreens, mutual capacitance touchscreens, self-capacitance touchscreens, infrared grid touchscreens, infrared acrylic projection touchscreens, optical touchscreens, touchscreens based on dispersive signal technology, acoustic pulse recognition touchscreens, and the like. In various embodiments, touchscreen/display control 620 may receive inputs from the touchscreen and process the received inputs. Touchscreen/display control 620 also may control the display on PoS device 600, thereby providing the graphical user interface on a display to a user of PoS device 600.

Display 622 may be any display suitable for a PoS device. For example, display 622 may be a TFT, LCD, LED or other display. Display 622 also may be a touchscreen display that for example allows a user to interact with PoS device 600 through simple or multi-touch gestures by touching a screen or display (e.g., display 622). Display 622 may include any number of touchscreens, including, for example, resistive touchscreens, surface acoustic wave touchscreens, capacitive touchscreens, surface capacitance touchscreens, projected capacitance touchscreens, mutual capacitance touchscreens, self-capacitance touchscreens, infrared grid touchscreens, infrared acrylic projection touchscreens, optical touchscreens, touchscreens based on dispersive signal technology, acoustic pulse recognition touchscreens, and the like. In various embodiments, 622 may receive inputs from control gestures provided by a user. Display 622 also may display images, thereby providing the graphical user interface to a user of PoS device 600.

Cash register/retail enterprise system 624 may me any device or devices that cooperate with PoS device 600 to process transactions. Cash register/retail enterprise system 624 may be coupled with other components of PoS device 600 via, for example, a data interface (e.g., data interface 606) as illustrated in FIG. 6. Cash register/retail enterprise system 624 also may be integrated into PoS device 600.

In various embodiments, cash register/retail enterprise system 624 may be a cash register. Example cash registers may include, for example, mechanical or electronic devices that calculate and record sales transactions. Cash registers also may include a cash drawer for storing cash and may be capable of printing receipts. Cash registers also may be connected to a network to enable payment transactions. Cash registers may include a numerical pad, QWERTY or custom keyboard, touch screen interface, or a combination of these input methods for a cashier to enter products and fees by hand and access information necessary to complete the sale.

In various embodiments, cash register/retail enterprise system 624 may comprise an retail enterprise system and/or a customer relationship management system. Retail enterprise system 624 may enable retain enterprises to manage operations and performance across a retail operation. Retail enterprise system 624 may be a stand-alone application in, for example, individual stores, or may be interconnected via a network. Retail enterprise system 624 may include various point of sale capabilities, including the ability to, for example, customize and resize transaction screens, work with a “touch screen” graphical user interface, enter line items, automatically look up price (sales, quantity discount, promotional, price levels), automatically compute tax, VAT, look up quantity and item attribute, display item picture, extended description, and sub-descriptions, establish default shipping services, select shipping carrier and calculate shipping charges by weight/value, support multi-tender transactions, including cash, check, credit card, and debit card, accept food stamps, place transactions on hold and recall, perform voids and returns at POS, access online credit card authorizations and capture electronic signatures, integrate debit and credit card processing, ensure optional credit card discounts with address verification, support mix-and-match pricing structure, discount entire sale or selected items at time of sale, add customer account, track customer information, including total sales, number of visits, and last visit date. issue store credit, receive payment(s) for individual invoices, process deposits on orders, search by customer's ship-to address, create and process layaway, back orders, work orders, and sales quotes, credit items sold to selected sales reps, view daily sales graph at the PoS, view and print journals from any register, preview, search, and print journals by register, batch, and/or receipt number, print X, Z, and ZZ reports, print receipts, invoices, and pick tickets with logos/graphics, print kit components on receipt, reprint receipts, enter employee hours with an integrated time clock function, and/or sell when the network/server is down with an offline PoS mode. Retail enterprise system 624 also may include inventory control and tracking capabilities, reporting tools, customer management capabilities, employee management tools, and may integrate with other accounting software.

In various embodiments cash register/retail enterprise system 624 may be a hospitality PoS. In such embodiments, retail enterprise system 624 may include hospitality PoS software (e.g, Aloha PoS Restaurant software from NCR®, Micros® RES and Symphony software and the like), hospitality management software, and other hardware and software to facilitate hospitality operations.

Referring back to FIG. 1, financial institution 101 may provide an account holder 106 with one or more financial accounts. The financial account may be associated with the account holder's one or more mobile devices. The mobile device may be configured to act as a method of payment at a PoS location (merchant 105) using, for example, NFC or any other mobile payment technology. When account holder 106 uses his mobile device at a PoS location to perform a financial transaction, the financial transaction may be charged to the mobile payment account. For example, the account holder 106 may use the device in lieu of a credit card to make a purchase merchant 105. The purchase would then be charged to the mobile payment account associated with the account holder device 106. The mobile payment account may be stored in an account database at financial institution 101. The account may be a traditional credit card account where the account holder uses a credit card, rewards card, debit card, or similar method of payment to purchase goods and services from one or more merchants 107.

As described in reference to FIG. 1, transaction processor 102 may be configured to receive transaction data from merchant 105. The transaction data may be received from a third-party, such as a payment processor. The transaction data may be received from one or more financial institutions. The transaction data may comprise information related to a transaction between account holder 106 and merchant 105. The transaction may have been performed at a PoS terminal using one or more cards of the account holder 106. The transaction data may include a date and time. The transaction data may include an account identifier that identifies the one or more accounts charged for the transaction. The transaction data may include location data. The location data may be a city, zip code, county, region, state, or other regional geographical information. The transaction data may include the merchant type or category, such as, for example, (restaurant, coffee shop, clothing store, grocery store, electronics, or other type of merchant). The transaction data may include the name of the merchant 105. The transaction data may include a merchant identifier. The merchant identifier may be a unique identifier associated with the merchant 105 and/or the one or more PoS terminals at merchant 105. It may be a series of letters, numbers, or other characters that includes information that is common to every transaction performed at that merchant.

Geocoding processor 103 may retrieve merchant location data based on the transaction location data. Merchant location data may include geographical location data for every store location for merchant 105 that falls within the transaction location data. For example, if the transaction location data included a zip code, geocoding processor 103 would retrieve merchant location data for every store (belonging to merchant 105) that was located within that zip code. If the transaction data indicated that the transaction occurred at a Starbucks in the zip code 23220, then geocoding processor 103 would retrieve merchant location data for every Starbucks location in the 23220 zip code. The merchant location data may include a street address for one or more stores. The merchant location data may include GPS coordinates for each store location. The merchant location data may include latitude and longitude information for each store location. The merchant location data may be retrieved based on the transaction location data, the merchant name (from the transaction data), or other transaction data. The merchant location data may be retrieved from, e.g., merchant 105. The merchant location data may be retrieved from financial institution 101. The merchant location data may be retrieved from one or more third parties.

Geocoding processor 103 may compile a list of every store or physical location that merchant 105 has within the area specified by the transaction location data. For example, if account holder A bought coffee at a Starbucks store, the transaction location data for that purchase may only include a zip code. In this case, geocoding processor 103 would retrieve merchant location data for every Starbucks store that was located within that zip code. If the transaction data indicated that the transaction occurred at a Starbucks in the zip code 23220, then geocoding processor 103 would retrieve merchant location data for every Starbucks location in the 23220 zip code and compile a list that included the merchant location data for each Starbucks store in the 23220 zip code.

Geocoding processor 103 may retrieve transaction history data for account holder 106 based on the transaction data (which may include an account identifier associated with account holder 106). The transaction history data may be retrieved from transactions database 104. The transaction history data may include a list of every past transactions that account holder 106 conducted over a certain time period in or around the geographical area specified by the transaction location data described above. The time period may be, for example, the past week, month, quarter, year, or other period of time. Each past transaction in the transaction history may include, for example, a transaction amount, a date and time of the transaction, a transaction identifier, the merchant name, the merchant category, an account identifier, and geocoded information. The geocoded information may be a street address, GPS coordinates, latitude and longitude, or other geographical information associated that identifies the location where the past transaction took place.

Geocoding processor 103 may create one or more purchase clusters of past transactions based on the geocoded information associated with each transaction. Each cluster may include a plurality of past transactions that have similar geocoded information. Two sets of geocoded information may be considered similar if they are within a certain maximum distance of one another. The maximum difference may be preset or determined by geocoding processor 103.

For example, if account holder A has made twenty purchases at a shopping mall in Richmond, Va. over the past six months, geocoding processor 103 may create a purchase cluster based on the geocoded information associated with each of the twenty purchases. The geocoded information may be latitude and longitude coordinates of the merchants where the purchases were made. Geocoding processor 103 may label and store the purchase clusters.

In another example, account holder A's primary residence in Richmond may be within walking distance of a number of merchants. Geocoding processor 103 may review account holder A's transaction history data and determine that account holder A made thirty purchases made over the past two months within a quarter-mile radius of account holder A's home address. Geocoding processor may create a purchase cluster based on the geocoded information for each of the thirty transactions.

For each purchase cluster, geocoding processor 103 may determine a cluster geolocation by averaging the geocoded information of every transaction in that purchase cluster. Geocoding processor 103 may determine the cluster geolocation based on a representative transaction from each cluster and assign that as the cluster geolocation for that cluster. Geocoding processor 103 may determine the median geolocation for a cluster and assign that as the cluster geolocation.

Geocoding processor 103 may further refine or determine other clusters by using date and/or time data associated with each transaction from the account holder's transaction history data. For example, geocoding processor 103 may create a purchase cluster based on geocoded information from transactions made every Monday of the past six months. Geocoding processor 103 may create a purchase cluster based on geocoded information from transactions made on weekends. Geocoding processor 103 may create a purchase cluster based on geocoded information from transactions made in the evenings. These and other factors may be used. In this way, geocoding processor 103 may create a “heat map” showing locations where an account holder is likely to shop based on past transactions.

For each purchase cluster, geocoding processor 103 may determine the distance between its cluster geolocation and each store that merchant 105 has within the area of the transaction location data for the current transaction. Using the Starbucks example from above, geocoding processor 103 would compare the cluster geolocation of each purchase cluster to the physical location of each Starbucks store in the 23220 zip code. If the transaction location data merely indicated that the Starbucks is located in the city of Richmond, then geocoding processor 103 would compare the cluster geolocation of each purchase cluster with the physical location of each Starbucks located in the city of Richmond.

Geocoding processor 103 may determine which store location is most likely associated with the transaction data based on the purchase clusters and calculated distances between each cluster geolocation and each of the stores.

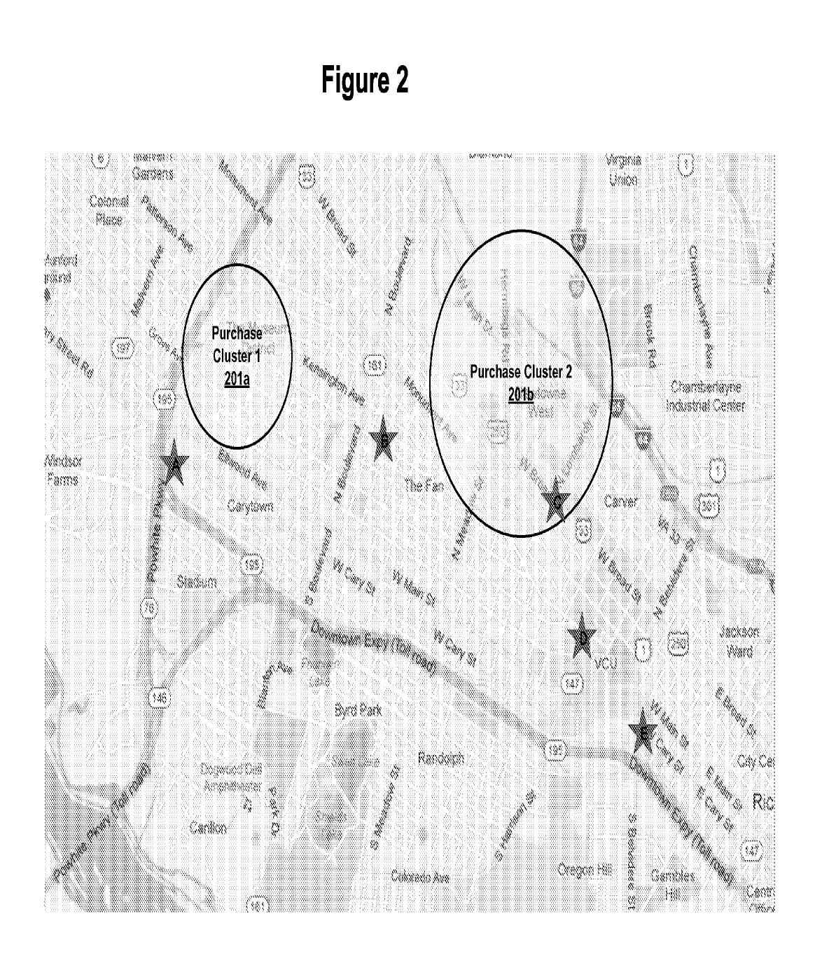

For example, FIG. 2 shows a map 200 overlayed with two purchase clusters (201a and 201b). In this example, the area shown on the map may represent the location corresponding to the transaction location data from account holder A's most recent Starbucks purchase. The location data for the purchase may only note that the purchase occurred in Richmond, Va. Geocoding processor may create one or more purchase clusters based on account holder A's purchase history data for purchases within Richmond, Va. Cluster 201a may comprise data from thirty past geocoded transactions. Cluster 201b may comprise data from fifty other geocoded transactions. FIG. 2 also shows the physical locations A-E of each Starbucks store within the area specified in the transaction location data (Richmond, Va.).

Referring to FIG. 2, geocoding processor 103 may determine the distance between the cluster geolocation of cluster 1 (roughly the center of the circle 201a) and each of the Starbucks locations A-E. Geocoding processor 103 may determine that location A is the closest Starbucks store to cluster 1. Geocoding processor 103 may do the same for cluster 2 and determine that location C is the closest Starbucks store to cluster 2. Geocoding processor 103 may determine that the Starbucks located at location C is most likely to be the one where the account holder made the transaction in question. This may be, for example, because purchase cluster 2 is based on fifty purchases, while purchase cluster 1 is only based on thirty purchases.

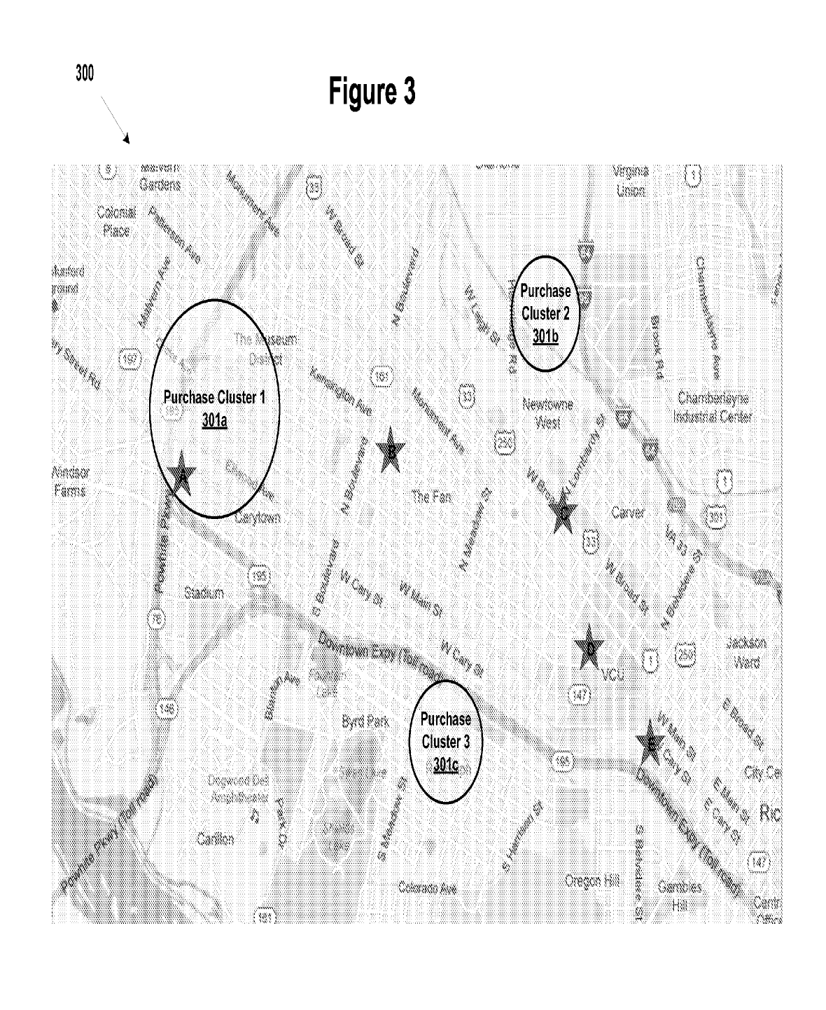

Referring to FIG. 3, which depicts a map 300 overlayed with purchase clusters, geocoding processor 103 may take the same transaction history data and further refine the purchase clusters or create new ones based on the date associated with the transaction data. For example, assume account holder A made the Starbucks purchase on a Monday. Geocoding processor 103 may use account holder A's transaction history data to create one or more purchase clusters using past geocoded transactions that occurred on a Monday. As shown in FIG. 3, purchase cluster 1 (301a) may be based on 15 transactions that occurred on a Monday, while purchase clusters 2 and 3 (301b and 301c) may be based on four transactions each. Accordingly, geocoding processor 103 may determine that the Starbucks corresponding to location A is the most likely location where account holder A made the current transaction.

Other factors and points of comparison may be used, such as creating clusters based on time, or merchant category.

Geocoding processor 103 may geocode the transaction based on the previous determination. Geocoding processor 103 may update the location data associated with the transaction to include the physical location of the merchant. So, for example, referring to FIG. 3, geocoding processor 103 would update the transaction data to include the physical location of the Starbucks at location A.

Geocoding processor 103 also may further refine the process based on a merchant identifier included in the transaction data. The merchant identifier may be a unique identifier associated with the merchant 105 and/or the one or more PoS terminals at merchant 105. It may be a series of letters, numbers, or other characters that includes information that is common to every transaction performed at that merchant. Geocoding processor 103 may perform the steps outlined above with respect to the account holder and create one or more purchase clusters and compare their locations with the physical locations of each store of merchant 105. Geocoding processor 103 may then retrieve or otherwise obtain the transaction history data for every other account holder with a transaction that includes the same merchant identifier. Geocoding processor 103 may then create one or more purchase clusters for each account holder and compare those spend cluster locations with the locations of each store of merchant 105.

For example, assume account holder A made a purchase at a Starbucks in Richmond, Va. and that the transaction data associated with that purchase only included the city where the store is located. In this example, the transaction data may also include a unique merchant identifier. For example, a credit card swipe PoS terminal at the Starbucks location may add a unique merchant identifier to every transaction. In this example, the identifier may be SBUCKS_123*. Transaction processor 102 and geocoding processor 103 may use this information and account holder A's past geocoded transaction data to create one or more purchase clusters for account holder A and compare the cluster geolocation of each to the location of each Starbucks store in Richmond, Va., as described previously.

Geocoding processor 103 may then perform the same steps for each account holder with a transaction having the merchant identifier SBUCKS_123*. For example, assume account holders B, C, D, and E all have made transactions that include the merchant identifier SBUCKS_123*. Geocoding processor 103 may prepare one or more purchase clusters for each of account holders B, C, D, and E (using the same process as was used for account holder A). Geocoding processor 103 may then compare the physical locations for each Starbucks in Richmond with the cluster geolocation for each of the purchase clusters for account holders B, C, D, and E.

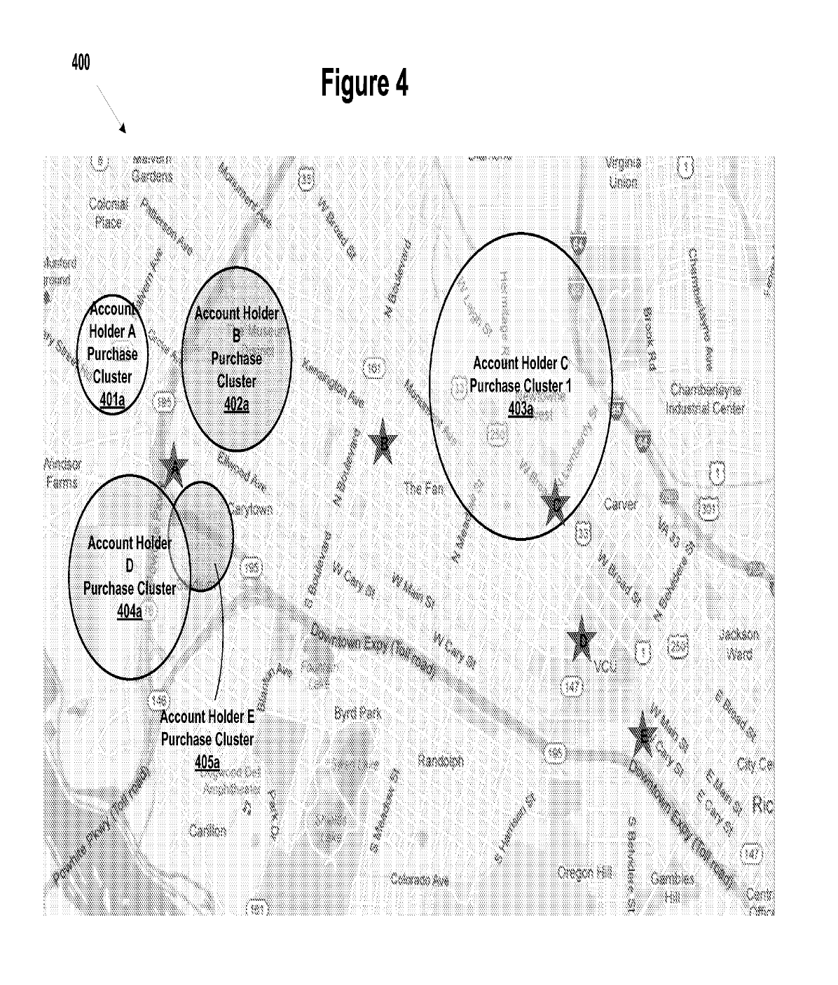

FIG. 4 is an example depiction of a map 400 overlayed with purchase clusters from each of account holder A (401a), account holder B (402a), account holder C (403a), account holder D (404a), and account holder E (405a). While in this example, each account holder only has one purchase cluster, each account holder may have multiple purchase clusters in other embodiments, depending on the transaction history data for each account holder.

As can be seen in FIG. 4, geocoding processor 103 may determine that Starbucks located at location A is most likely the location where account holder A made the purchase. This may be because the majority of the clusters are closest to the Starbucks at location A. In other embodiments, the number of purchases in each cluster may be taken into account in determining the weight to afford to each cluster location and its proximity to each merchant location. As in the case of purchase clusters for a single account holder, this process may be further refined based on the date and time of the transaction and/or the merchant category.

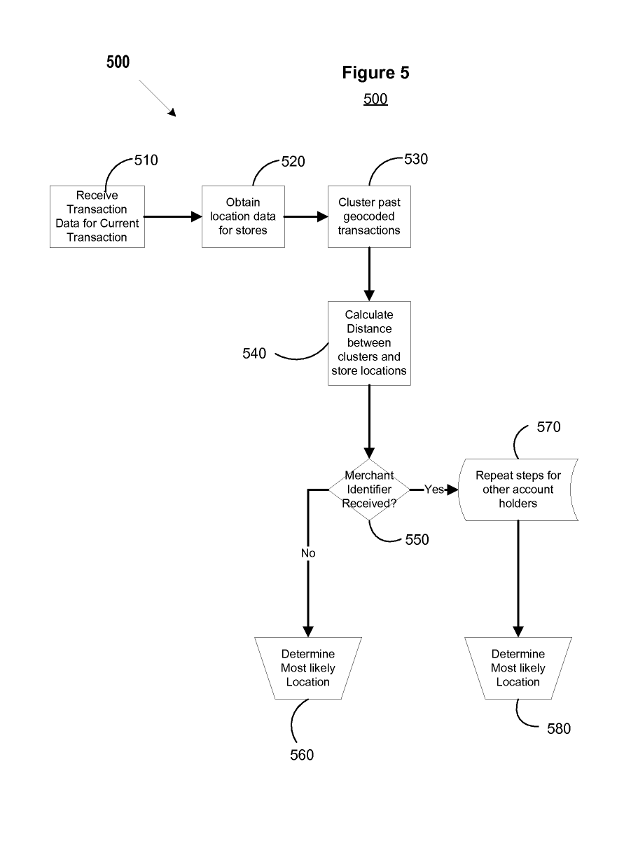

FIG. 5 depicts an example system 500 that may enable a financial institution, for example, to provide network services to its customers. As shown in FIG. 5, system 500 may include a client device 502, a network 504, a front-end controlled domain 506, a back-end controlled domain 512, and a backend 518. Front-end controlled domain 506 may include one or more load balancers 508 and one or more web servers 510. Back-end controlled domain 512 may include one or more load balancers 514 and one or more application servers 516.

Client device 502 may be a network-enabled computer: As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 500 may execute one or more software applications to enable, for example, network communications.

Client device 502 also may be a mobile device: For example, a mobile device may include an iPhone, iPod, iPad from Apple® or any other mobile device running Apple's iOS operating system, any device running Google's Android® operating system, including for example, Google's wearable device, Google Glass, any device running Microsoft's Windows® Mobile operating system, and/or any other smartphone or like wearable mobile device.

Network 504 may be one or more of a wireless network, a wired network, or any combination of a wireless network and a wired network. For example, network 504 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 504 may include, without limitation, telephone lines, fiber optics, IEEE Ethernet 902.3, a wide area network (WAN), a local area network (LAN) or a global network such as the Internet. Also, network 504 may support an Internet network, a wireless communication network, a cellular network, or the like, or any combination thereof. Network 504 may further include one network, or any number of example types of networks mentioned above, operating as a stand-alone network or in cooperation with each other. Network 504 may utilize one or more protocols of one or more network elements to which they are communicatively couples. Network 504 may translate to or from other protocols to one or more protocols of network devices. Although network 504 is depicted as a single network, it should be appreciated that according to one or more embodiments, network 504 may comprise a plurality of interconnected networks, such as, for example, the Internet, a service provider's network, a cable television network, corporate networks, and home networks.

Front-end controlled domain 506 may be implemented to to provide security for backend 518. Load balancer(s) 508 may distribute workloads across multiple computing resources, such as, for example computers, a computer cluster, network links, central processing units or disk drives. In various embodiments, load balancer(s) 510 may distribute workloads across, for example, web server(S) 516 and/or backend 518 systems. Load balancing aims to optimize resource use, maximize throughput, minimize response time, and avoid overload of any one of the resources. Using multiple components with load balancing instead of a single component may increase reliability through redundancy. Load balancing is usually provided by dedicated software or hardware, such as a multilayer switch or a Domain Name System (DNS) server process.

Load balancer(s) 508 may include software that monitoring the port where external clients, such as, for example, client device 502, connect to access various services of a financial institution, for example. Load balancer(s) 508 may forward requests to one of the application servers 516 and/or backend 518 servers, which may then reply to load balancer 508. This may allow load balancer(s) 508 to reply to client device 502 without client device 502 ever knowing about the internal separation of functions. It also may prevent client devices from contacting backend servers directly, which may have security benefits by hiding the structure of the internal network and preventing attacks on backend 518 or unrelated services running on other ports, for example.

A variety of scheduling algorithms may be used by load balancer(s) 508 to determine which backend server to send a request to. Simple algorithms may include, for example, random choice or round robin. Load balancers 508 also may account for additional factors, such as a server's reported load, recent response times, up/down status (determined by a monitoring poll of some kind), number of active connections, geographic location, capabilities, or how much traffic it has recently been assigned.

Load balancers 508 may be implemented in hardware and/or software. Load balancer(s) 508 may implement numerous features, including, without limitation: asymmetric loading; Priority activation: SSL Offload and Acceleration; Distributed Denial of Service (DDoS) attack protection; HTTP compression; TCP offloading; TCP buffering; direct server return; health checking; HTTP caching; content filtering; HTTP security; priority queuing; rate shaping; content-aware switching; client authentication; programmatic traffic manipulation; firewall; intrusion prevention systems.

Web server(s) 510 may include hardware (e.g., one or more computers) and/or software (e.g., one or more applications) that deliver web content that can be accessed by, for example a client device (e.g., client device 502) through a network (e.g., network 504), such as the Internet. In various examples, web servers, may deliver web pages, relating to, for example, online banking applications and the like, to clients (e.g., client device 502). Web server(s) 510 may use, for example, a hypertext transfer protocol (HTTP or sHTTP) to communicate with client device 502. The web pages delivered to client device may include, for example, HTML documents, which may include images, style sheets and scripts in addition to text content.

A user agent, such as, for example, a web browser, web crawler, or native mobile application, may initiate communication by making a request for a specific resource using HTTP and web server 510 may respond with the content of that resource or an error message if unable to do so. The resource may be, for example a file on stored on backend 518. Web server(s) 510 also may enable or facilitate receiving content from client device 502 so client device 502 may be able to, for example, submit web forms, including uploading of files.

Web server(s) also may support server-side scripting using, for example, Active Server Pages (ASP), PHP, or other scripting languages. Accordingly, the behavior of web server(s) 510 can be scripted in separate files, while the actual server software remains unchanged.

Load balancers 514 may be similar to load balancers 508 as described above.

Application server(s) 516 may include hardware and/or software that is dedicated to the efficient execution of procedures (e.g., programs, routines, scripts) for supporting its applied applications. Application server(s) 516 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Also, application server(s) 516 may act as a set of components accessible to, for example, a financial institution or other entity implementing system 500, through an API defined by the platform itself. For Web applications, these components may be performed in, for example, the same running environment as web server(s) 510, and application servers 516 may support the construction of dynamic pages. Application server(s) 516 also may implement services, such as, for example, clustering, fail-over, and load-balancing. In various embodiments, where application server(s) 516 are Java application servers, the web server(s) 516 may behaves like an extended virtual machine for running applications, transparently handling connections to databases associated with backend 518 on one side, and, connections to the Web client (e.g., client device 502) on the other.

Backend 518 may include hardware and/or software that enables the backend services of, for example, a financial institution or other entity that maintains a distributes system similar to system 500. For example, backend 518 may include, a system of record, online banking applications, a rewards platform, a payments platform, a lending platform, including the various services associated with, for example, auto and home lending platforms, a statement processing platform, one or more platforms that provide mobile services, one or more platforms that provide online services, a card provisioning platform, a general ledger system, and the like. Backend 518 may be associated with various databases, including account databases that maintain, for example, customer account information, product databases that maintain information about products and services available to customers, content databases that store content associated with, for example, a financial institution, and the like. Backend 518 also may be associated with one or more servers that enable the various services provided by system 500, such as, for example, the ability to determine transaction locations based on geocoded information and transaction history. For example, backend 518 may include or be associated with various databases that store transaction histories, merchant location information, and the like and various processors that can determine a transaction location using, for example, the methods described herein based on transaction histories, merchant location information, and the like.

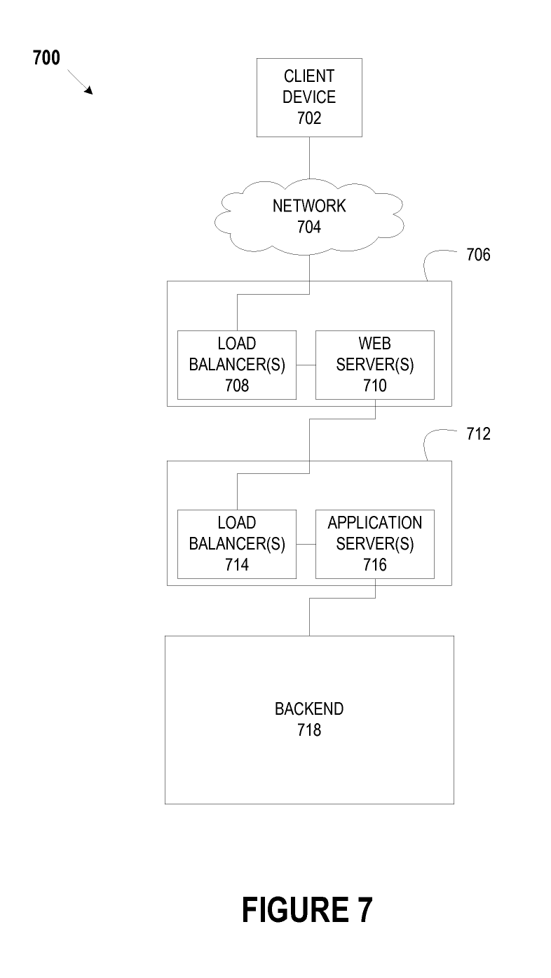

FIG. 7 is a flow chart illustrating a method for geocoding a transaction based on past transaction data. This example method is provided by way of example. The method 700 shown in FIG. 7 can be executed or otherwise performed by one or more combinations of various systems. The method 700 as described below may be carried out by the systems for determining a transaction location based on geocoded information as shown in FIGS. 1, 5, and 6, by way of example, and various elements of that system are referenced in explaining the method of FIG. 7. Each block shown in FIG. 7 represents one or more processes, methods, or subroutines in the example method 700. Referring to FIG. 7, the example method 700 may begin at block 710.

In block 710, method 700 may include receiving transaction data for a current transaction. The transaction data may comprise information related to a transaction between account holder 106 and merchant 105. The transaction may have been performed at a PoS terminal at one of merchant 105's store locations using one or more cards of the account holder 106. The transaction data may include a date and time of the transaction. The transaction data may include an account identifier that identifies the one or more accounts charged for the transaction. The transaction data may include location data for where the transaction was performed. The location data may include a city, zip code, county, region, state, or other regional geographical information. The transaction data may include the merchant type or category, such as, for example, (restaurant, coffee shop, clothing store, grocery store, electronics, or other type of merchant). The transaction data may include the name of the merchant 105. The transaction data may include a merchant identifier. The merchant identifier may be a unique identifier associated with the merchant 105 and/or the one or more PoS terminals at merchant 105. It may be a series of letters, numbers, or other characters that includes information that is common to every transaction performed at that merchant. The transaction information bay be received from an account holder, merchant, and/or authorization network associated with, for example, processing the transaction.

At step 720, geocoding processor 103 may retrieve merchant location data for the store locations of merchant 105 based on the transaction location data. Merchant location data may include geographical location data for every store location for merchant 105 that falls within the transaction location data. For example, if the transaction location data included a zip code, geocoding processor 103 would retrieve merchant location data for every store (belonging to merchant 105) that was located within that zip code. The merchant location data may include a street address for one or more stores. The merchant location data may include GPS coordinates for each store location. The merchant location data may include latitude and longitude information for each store location. The merchant location data may be retrieved based on the transaction location data, the merchant name (from the transaction data), or other transaction data.

Geocoding processor 103 may compile a list of every store or physical location that merchant 105 has within the area specified by the transaction location data. For example, if account holder A bought lunch at a Panera store, the transaction location data for that purchase may only include the city of Alexandria, Va. In this example, geocoding processor 103 would retrieve merchant location data for every Panera store that was located within Alexandria and compile a list that included the merchant location data for each Panera in Alexandria.

At step 730, method 700 may create one or more purchase clusters based on the account holder's prior geocoded transactions. Geocoding processor 103 may retrieve transaction history data for account holder 106. The transaction history data may be retrieved from transactions database 104. The transaction history data may include a list of transactions that account holder 106 conducted over a certain time period in or around the geographical area specified by the transaction location data described above. The time period may be, for example, the past week, month, quarter, year, or other period of time. Each past transaction in the transaction history may include, for example, a transaction amount, a date and time of the transaction, a transaction identifier, the merchant name, the merchant category, an account identifier, and geocoded information for that transaction. The geocoded information may be a street address, GPS coordinates, latitude and longitude, or other geographical information that identifies the location where the past transaction took place.

Geocoding processor 103 may create one or more purchase clusters of past transactions based on the geocoded information associated with each transaction. Each cluster may include a plurality of past transactions that have similar geocoded information. Two sets of geocoded transactions may be considered similar if they are within a certain maximum distance of one another. The maximum difference may be preset or determined by geocoding processor 103.

For example, if account holder A has made twenty purchases at a shopping mall in Alexandria, Va. over the past six months, geocoding processor 103 may create a purchase cluster based on the geocoded information associated with each of the twenty purchases. The geocoded information may be latitude and longitude coordinates of the merchants where the purchases were made. Geocoding processor 103 may label and store the purchase clusters.

In another example, account holder A's primary residence in Alexandria may be within walking distance of a number of merchants. Geocoding processor 103 may review account holder A's transaction history data and determine that account holder A made thirty purchases made over the past two months within a quarter-mile radius of account holder A's home address. Geocoding processor may create a purchase cluster based on the geocoded information for each of the thirty transactions.

For each purchase cluster, geocoding processor 103 may determine a cluster geolocation by averaging the geocoded information of every transaction in that purchase cluster. Geocoding processor 103 may determine the cluster geolocation based on a representative transaction from each cluster and assign that as the cluster geolocation for that cluster. Geocoding processor 103 may determine the median geolocation for a cluster and assign that as the cluster geolocation.

Geocoding processor 103 may further refine or determine other clusters by using date and/or time data associated with each transaction from the account holder's transaction history data. For example, geocoding processor 103 may create a purchase cluster based on geocoded information from transactions made every Monday over the past six months. Geocoding processor 103 may create a purchase cluster based on geocoded information from transactions made on weekends. Geocoding processor 103 may create a purchase cluster based on geocoded information from transactions made in the evenings. These and other factors may be used. In this way, geocoding processor 103 may create a “heat map” showing locations where an account holder is likely to shop based on past transactions.

At step 740, for each purchase cluster, method 700 may determine the distance between its cluster geolocation and each store that merchant 105 has within the area of the transaction location data for the current transaction. Using the Panera example from above, geocoding processor 103 would compare the cluster geolocation of each purchase cluster to the physical location of each Panera store in Alexandria, Va.

At step 750, method 700 may determine if a merchant identifier was received with the current transaction data. The merchant identifier may be a unique identifier associated with the merchant 105 and/or the one or more PoS terminals at merchant 105. It may be a series of letters, numbers, or other characters that includes information that is common to every transaction performed at that merchant.

At step 760, if no merchant identifier was received with the current transaction data, method 700 may determine which store location is most likely associated with the current transaction data based on the purchase clusters and calculated distances between each cluster geolocation and each of the stores. Using the Panera example, geocoding processor 103 may determine which Panera store location within Alexandria is most likely where account holder A made the current transaction based on the each store's proximity to the one or more purchase clusters. The determination may be based on the number of transactions comprising each purchase cluster. The determination may be based on the date and time of the transactions in each purchase cluster compared to the date and time of the current transaction. The determination may be based on the merchant categories of the transactions in the each of the purchase clusters. The determination may be based on some combination of these factors.

At block 770, if a merchant identifier was received with the current transaction data, method 700 may repeat steps 730 and 740 for all other account holders who have made a transaction that includes the same merchant identifier. Using the Panera example, if account holder A's current transaction data included the merchant identifier PanBread 321*, then geocoding processor 103 would create one or more purchase clusters for all account holders with a transaction that includes the merchant identifier PanBread 321*. For example, assume account holders B, C, D, and E all have made transactions that include the merchant identifier PanBread 321*. Geocoding processor 103 may prepare one or more purchase clusters for each of account holders B, C, D, and E (using the same process as was used for account holder A described in step 730). Geocoding processor 103 may then compare the physical locations for each Panera in Alexandria with the cluster geolocation for each of the purchase clusters for account holders B, C, D, and E (as described in step 740).

At step 780, method 700 may determine which Panera store location within Alexandria is most likely where account holder A made the current transaction based on the each store's proximity to the one or more account holder A's purchase clusters, as well as the purchase clusters for account holders B-E. The determination may be based on the number of transactions comprising each purchase cluster. The determination may be based on the date and time of the transactions in each purchase cluster compared to the date and time of the current transaction. The determination may be based on the merchant categories of the transactions in the each of the purchase clusters. The determination may be based on some combination of these factors.

It is further noted that the software described herein maybe tangibly embodied in one of more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, processors, etc.) separately. The functions described as being performed at various components may be performed at other components, and the various components bay be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

We claim:

1. A system for determining a transaction location based on transaction history data, comprising:
a first database that stores transaction history data related to a plurality of account holders;
a second database that stores location data for a plurality of locations, wherein each of the plurality of locations is associated with a respective merchant store location;
a receiver that receives, via a network, transaction data associated with one of the plurality of account holders' recent transaction;
a location data processor that obtains the location data for a plurality of locations;
a transaction history processor that retrieves transaction history data associated with the account holder from a transaction history data store associated with a financial institution;
a location prediction processor that creates one or more transactions clusters based on the transaction history data, analyzes a location associated with each of the transaction clusters and the location data, and determines a predicted transaction location based on the analysis of the one or more transaction clusters and the location data, wherein the predicted transaction location is one of the plurality of locations associated with the respective merchant store locations.

2. The system of claim 1, wherein:
the receiver receives a merchant identifier associated with the transaction data,
the transaction history processor retrieves transaction history data for a plurality of other account holders based on the merchant identifier, and
the location prediction processor creates one or more transaction clusters for each of the plurality of other account holders based on the retrieved transaction history data, compares a location associated with each of the transaction clusters with the location data, and updates the predicted transaction location based the comparison between the one or more transaction clusters and the location data.

3. The system of claim 1, wherein the location data processor, transaction history processor, location prediction processor are the same processor.

4. The system of claim 1, wherein the location data processor, transaction history processor, location prediction processor are different processors.

5. The system of claim 1, wherein the location data for a plurality of locations includes global positioning coordinate data.

6. The system of claim 1, wherein the predicted transaction location includes global positioning coordinate data.

7. The system of claim 1, wherein the predicted transaction location is associated with the recent transaction of the account holder.

8. The system of claim 1, wherein the first and second databases are different databases.

9. The system of claim 1, wherein, to analyze the location associated with each of the transaction clusters and the location data, the location prediction processor compares a location associated with each of the transaction clusters with the location data.

10. The system of claim 1, wherein the location prediction processor determines whether the a location associated with the location data is within the location associated with one of the transaction clusters.

11. A method for determining a transaction location based on transaction history data, comprising:
storing, in a first database, transaction history data related to a plurality of account holders;
storing, in a second database, location data for a plurality of locations, wherein each of the plurality of locations is associated with a respective merchant store location;
receiving, via a network, transaction data associated with one of the plurality of account holders' recent transaction;
obtaining, using a location data processor, the location data for a plurality of locations;
retrieving, using a transaction history processor, transaction history data associated with the account holder from a transaction history data store associated with a financial institution;
creating, using a location prediction processor, one or more transactions clusters based on the transaction history data;
analyzing, using the location prediction processor, a location associated with each of the transaction clusters and the location data; and
determining, using the location prediction processor, a predicted transaction location based on the analysis of the one or more transaction clusters and the location data,
wherein the predicted transaction location is one of the plurality of locations associated with the respective merchant store locations.

12. The method of claim 11, further comprising:
receiving a merchant identifier associated with the transaction data;
retrieving, using the transaction history processor, transaction history data for a plurality of other account holders based on the merchant identifier;
creating, using the location prediction processor, one or more transaction clusters for each of the plurality of other account holders based on the retrieved transaction history data;
comparing, using the location prediction processor, a location associated with each of the transaction clusters with the location data; and
updating, using the location prediction processor, the predicted transaction location based the comparison between the one or more transaction clusters and the location data.

13. The method of claim 11, wherein the location data processor, transaction history processor, location prediction processor are the same processor.

14. The method of claim 11, wherein the location data processor, transaction history processor, location prediction processor are different processors.

15. The method of claim 11, wherein the location data for a plurality of locations includes global positioning coordinate data.

16. The method of claim 11, wherein the predicted transaction location includes global positioning coordinate data.

17. The method of claim 11, wherein the predicted transaction location is associated with the recent transaction of the account holder.

18. The method of claim 11, wherein the first and second databases are different databases.

19. The method of claim 11, further comprising analyzing the location associated with each of the transaction clusters and the location data by comparing a location associated with each of the transaction clusters with the location data.

20. The method of claim 11, further comprising determining, using the location prediction processor, whether the a location associated with the location data is within the location associated with one of the transaction clusters.
